(19) United States
(12) Patent Application Publication
(10) Pub. No.: US 2020/0300025 A1
(43) Pub. Date: Sep. 24, 2020

(54) DOOR OPENING RESTRICTION DEVICE, AND OPENING OPERATION CONTROL METHOD FOR VEHICLE DOOR

(71) Applicant: AISIN SEIKI KABUSHIKI KAISHA, Kariya-shi (JP)

(72) Inventor: Shintaro SUZUKI, Kasugai-shi (JP)

(73) Assignee: AISIN SEIKI KABUSHIKI KAISHA, Kariya-shi (JP)

(21) Appl. No.: 16/086,172

(22) PCT Filed: Feb. 7, 2017
(86) PCT No.: PCT/JP2017/004297

§ 371 Date: Sep. 18, 2018

(30) Foreign Application Priority Data
Mar. 30, 2016 (JP) 2016-069601

(51) Int. Cl. E05F 15/70; E05C 17/00; E05F 15/73; B60Q 9/00

(52) U.S. Cl. CPC E05F 15/70; E05C 17/006; E05Y 2900/531; B60Q 9/008; E05F 15/73

(57) ABSTRACT

A door ECU includes a non-detection field calculation unit calculating a non-detection field of an obstacle with reference to a location of a proximity sensor arranged in a vehicle, a travel path calculation unit calculating a travel path until the vehicle comes to a stopped state, a non-detection field movement path calculation unit calculating a movement path of the non-detection field associated with the travel path of the vehicle, a door opening operation path calculation unit calculating an opening operation path of the vehicle door when the vehicle is in the stopped state, and a door opening restriction calculation unit generating a control signal of a door check device in order to restrict the opening operation angle of the vehicle door if the vehicle door may operate to open beyond the movement path of the non-detection field.

### TECHNICAL FIELD

The present invention relates to a door opening restriction device and an opening operation control method for a vehicle door.

### BACKGROUND ART

Some vehicle door units in related art include a door opening restriction device capable of restricting the opening operation angle of the vehicle door before the full open angle. For example, the door opening restriction device disclosed in Patent Document 1 restricts the opening operation angle of the vehicle door by the engagement between an engagement member on the door and an engagement member on the vehicle. Further, operation of the control switch allows arbitrary setting of the opening operation angle of the vehicle door where the engagement member on the door and the engagement member on the vehicle are engaged with each other.

The door opening restriction device disclosed in Patent Document 2 continuously measures the distance to an obstacle present in the opening operation direction of the vehicle door. After the vehicle has come to a stop, the door opening restriction device reads out the measurement record of the separation distance to the obstacle. Then, the door opening restriction device restricts the opening distance of the vehicle door, namely, the opening operation angle such that the opening distance of the vehicle door is smaller than the separation distance to the obstacle.

However, in the above-mentioned related art, in order to have an effective “separation distance to the obstacle” to be read out when the vehicle has come to a stop, at least the “opening operation direction of the vehicle door” at the vehicle location where the vehicle door will be opened has to match the “opening operation direction of the vehicle door” at the passing location in the past at which the separation distance to the obstacle was measured at the vehicle location. Thus, if the travel course is changed immediately before the vehicle stops in an attempt to avoid a detected obstacle, for example, door opening restriction control may not prevent contact between the vehicle door and the obstacle.

### PRIOR ART DOCUMENT

### Patent Document

### Patent Document 1: Japanese Laid-Open Patent Publication No. 2007-327215

### Patent Document 2: Japanese Patent No. 4062989

### SUMMARY OF THE INVENTION

### Problems that are to be Solved by the Invention

It is an objective of the present invention to provide a door opening restriction device and an opening operation control method for a vehicle door that more effectively prevent contact between the vehicle door and an obstacle even if the travel course is changed immediately before the vehicle stops.

### Means for Solving the Problem

In order to achieve the above objective, an aspect of the present invention provides a door opening restriction device including a non-detection field calculation unit that calculates, based on a sensor output of a proximity sensor arranged in a vehicle, a non-detection field of an obstacle with reference to a location of the proximity sensor; a travel path calculation unit that calculates, based on traveling information on the vehicle, a travel path until the vehicle comes to a stopped state; a non-detection field movement path calculation unit that calculates a movement path of the non-detection field associated with the travel path of the vehicle; a door opening operation path calculation unit that calculates an opening operation path of a vehicle door when the vehicle is in the stopped state; and a door opening restriction unit that restricts an opening operation angle of the vehicle door in a case where the vehicle door may operate to open beyond the movement path of the non-detection field.

In order to achieve the above objective, another aspect of the present invention provides an opening operation control method for a vehicle door including calculating, based on a sensor output of a proximity sensor arranged in a vehicle, a non-detection field of an obstacle with reference to a location of the proximity sensor; calculating, based on traveling information on the vehicle, a travel path until the vehicle comes to a stopped state; calculating a movement path of the non-detection field associated with the travel path of the vehicle; calculating an opening operation path of a vehicle door when the vehicle is in the stopped state; and restricting an opening operation angle of the vehicle door in a case where the vehicle door may operate to open beyond the movement path of the non-detection field.

### BRIEF DESCRIPTION OF THE DRAWINGS

FIG. 1 is a plan view showing a vehicle.

FIG. 2 is a schematic configuration diagram of a door opening restriction device.

FIG. 3 is a diagram showing an opening operation angle and an opening operation path of a vehicle door.

FIG. 4 is a diagram showing a detectable area of an obstacle formed by a corner sensor (proximity sensor) and obstacle detection fields, which are partitioned in accordance with the proximity distance of the obstacle.

FIG. 5 is a control block diagram of the door opening restriction device.

FIG. 6 is a flowchart showing a procedure of a door opening restriction operation.

FIG. 7 is a flowchart showing a procedure of door opening restriction control.

FIG. 8 is a diagram illustrating an operation of the door opening restriction device.

FIG. 9 is a diagram illustrating an operation of the door opening restriction device.

FIG. 10 is a diagram illustrating an operation of the door opening restriction device.

FIG. 11 is a diagram illustrating an operation of the door opening restriction device.

FIG. 12 is a diagram illustrating an operation of the door opening restriction device.

FIG. 13 is a diagram illustrating an operation of the door opening restriction device.

FIG. 14 is a diagram illustrating an operation of the door opening restriction device.

FIG. 15 is a diagram illustrating an operation of the door opening restriction device.

FIG. 16 is a diagram illustrating an operation of the door opening restriction device.

FIG. 17 is a diagram illustrating an operation of the door opening restriction device.

FIG. 18 is a diagram illustrating another example of a non-detection field calculation.

### EMBODIMENTS OF THE INVENTION

In the following, a door opening restriction device according to one embodiment of the present invention will be described with reference to the drawings.

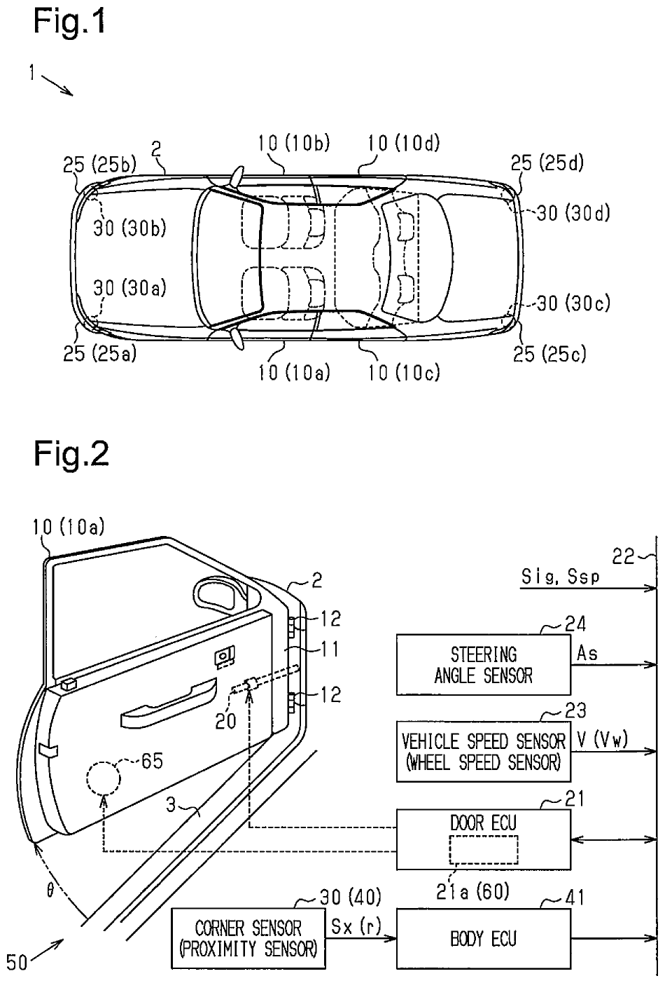

As shown in FIGS. 1 and 2, a vehicle 1 includes four vehicle doors 10 (10a to 10d) that each open and close a door opening 3 formed on a side of a vehicle body 2. The vehicle 1 is a four-door sedan automobile. Each vehicle door 10 is a swing door arranged at a position corresponding to each of the right and left seats in the front and rear of the passenger compartment.

A front end 11 of each vehicle door 10 is supported by the vehicle body 2 via a hinge 12. The door opening 3 of the vehicle 1 is opened or closed when each vehicle door 10 rotates on the hinge 12.

As shown in FIG. 2, each vehicle door 10 includes a door check device 20. The door check device 20 restricts an opening operation angle θ of each vehicle door 10. In other words, the door check device 20 prevents each vehicle 10 from opening beyond a preset restricted angle.

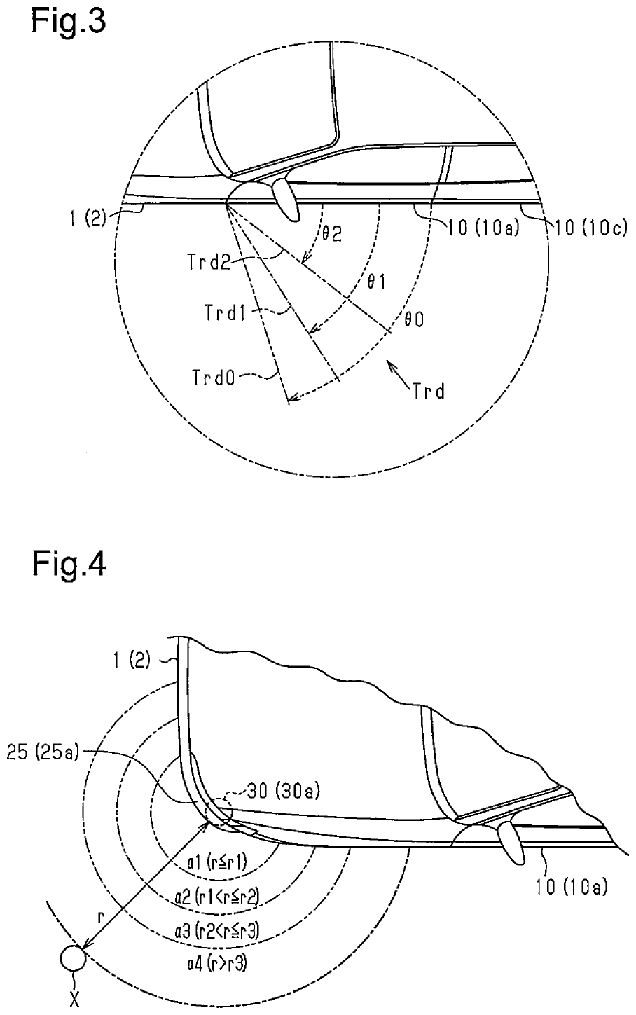

Specifically, as shown in FIGS. 2 and 3, the vehicle 1 is designed such that the opening operation angle θ of each vehicle door 10 in a full open state is equal to a predetermined angle (full open angle θ0). Further, the door check device 20 is configured to restrict the opening operation angle θ of the vehicle door 10 including the door check device 20 within a first restricted angle θ1 smaller than the full open angle θ0 or within a second restricted angle θ2 smaller than the first restricted angle θ1. The actuation of each door check device 20 is controlled by a door ECU 21.

More specifically, as shown in FIG. 2, the door ECU 21 obtains traveling information on the vehicle 1 via an in-vehicle network 22. That is, the door ECU 21 obtains, as a traveling state of the vehicle 1, a vehicle speed V (wheel speed Vw) detected by a vehicle speed sensor 23 and a steering angle As of the vehicle 1 detected by a steering angle sensor 24 included in the steering device (not shown). The door ECU 21 also obtains an ignition signal Sig and a shift position signal Ssp of the vehicle 1 via the in-vehicle network 22. Further, the door ECU 21 detects the traveling state of the vehicle 1 based on the obtained traveling information (V, Vw, As) and control signals (Sig, Ssp). The door ECU 21 controls the actuation of each door check device 20 in accordance with the detected traveling state of the vehicle 1.

As shown in FIGS. 1 and 4, the vehicle 1 includes corner sensors 30 (30a to 30d) for detecting proximity of an obstacle X to each corner 25 at respective corners 25 (25a to 25d) of the vehicle body 2.

As shown in FIG. 2, each of the corner sensors 30 employs a radio-wave, electrostatic capacitance, or ultrasonic proximity sensor 40, for example. A sensor output Sx of each corner sensor 30 is input to a body ECU 41. The body ECU 41 detects a proximity distance r of the obstacle X to each corner 25 of the vehicle body 2 on the basis of the sensor output Sx of the corner sensor 30. The body ECU 41 issues a warning indicative that the vehicle 1 is in proximity to the obstacle X on the basis of the proximity distance r of the detected obstacle X.

More specifically, as shown in FIG. 4, the body ECU 41 partitions the detectable area of the obstacle X formed by each corner sensor 30 into obstacle detection fields (α1 to α4) in accordance with the proximity distance r of the obstacle X to the corner 25. That is, the body ECU 41 defines an area with reference to (starting from) each corner 25 of the vehicle body 2 up to a first proximity distance r1 as a first obstacle detection field α1. Further, the body ECU 41 defines an area beyond the first proximity distance r1 up to a second proximity distance r2 as a second obstacle detection field α2. Further, the body ECU 41 defines an area beyond the second proximity distance r2 up to a third proximity distance r3 as a third obstacle detection field α3. Further, the body ECU 41 defines an area beyond the third proximity distance r3 as a fourth obstacle detection field α4.

If the body ECU 41 detects the obstacle X in the obstacle detection fields (α1 to α3) in or inside the third obstacle detection field α3, a loudspeaker (not shown) in the passenger compartment issues an alarm sound at predetermined intervals. In other words, if the obstacle X is present in the fourth obstacle detection field α4, the body ECU 41 does not issue the warning. Further, in proportion as the obstacle detection field where the obstacle X is detected comes closer to the corner sensor 30, namely, the corner 25 of the vehicle body 2, the body ECU 41 shortens the intervals of the alarm sound to be output and increases the volume of the alarm sound. This will urge the driver to operate in an attempt to avoid the obstacle X.

As shown in FIG. 2, the door ECU 21 obtains a sensor output Sx of each corner sensor 30 in a similar manner. Specifically, the door ECU 21 obtains the sensor output Sx of each corner sensor 30 from the body ECU 41 via the in-vehicle network 22. In particular, the door ECU 21 obtains a proximity distance r to the obstacle X indicated in the sensor output Sx. Further, the door ECU 21 controls the actuation of the door check device 20 of each vehicle door 10 based on the obtained sensor output Sx of each corner sensor 30. With the above-mentioned structure, the vehicle 1 includes a door opening restriction device 50 configured to restrict the opening operation angle θ of the vehicle door 10 in order to prevent contact with the obstacle X in proximity to the vehicle 1.

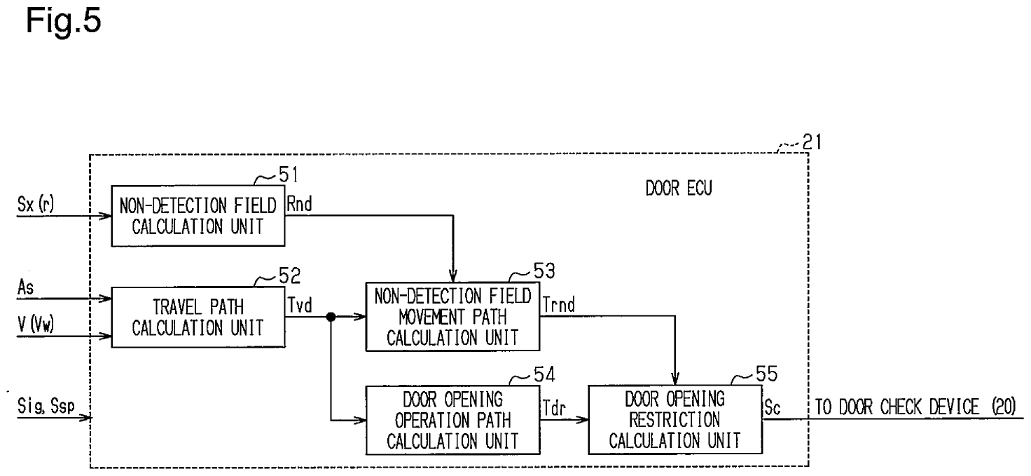

More specifically, as shown in FIG. 5, the door ECU 21 includes a non-detection field calculation unit 51 and a travel path calculation unit 52. The non-detection field calculation unit 51 calculates, based on the proximity distance r of the obstacle X indicated in the obtained sensor output Sx, a non-detection field Rnd of the obstacle X with reference to the location of each corner sensor 30, namely, the corner 25 of the vehicle body 2. The travel path calculation unit 52 calculates a travel path Tvd until the vehicle 1 comes to a stopped state based on the vehicle speed V (wheel speed Vw) and the steering angle As obtained as traveling information on the vehicle 1. The door ECU 21 also includes a non-detection field movement path calculation unit 53, a door opening operation path calculation unit 54, and a door opening restriction calculation unit 55. The non-detection field movement path calculation unit 53 calculates a movement path Trnd of the non-detection field Rnd associated with the travel path Tvd of the vehicle 1. The door opening operation path calculation unit 54 calculates an opening operation path Tdr of the vehicle door 10 when the vehicle 1 is in a stopped state. The door opening restriction calculation unit 55 generates, based on the calculation results of the non-detection field movement path calculation unit 53 and the door opening operation path calculation unit 54, a control signal Sc of the door check device 20 in order to restrict the opening operation angle θ of the vehicle door 10 if the vehicle door 10 may operate to open beyond the movement path Trnd of the non-detection field Rnd.

Specifically, if the obstacle X is detected based on the sensor output Sx of the corner sensor 30, the non-detection field calculation unit 51 sets the inside of the proximity distance r of the detected obstacle X as the non-detection field Rnd of the obstacle X, namely, an area where the obstacle X is not detected. In contrast, if the proximity of the obstacle X is not detected from the sensor output Sx of the corner sensor 30, the non-detection field calculation unit 51 sets, as the non-detection field Rnd of the obstacle X, the inside of a predetermined distance (rx) in which detection accuracy of the corner sensor 30 is ensured.

Each of the control blocks (51 to 55) is implemented by a computer program executed by an information processing device (a microcomputer and a memory) constituting the door ECU 21. In other words, the travel path calculation unit 52 establishes a vehicle model (such as a two-wheel vehicle model) based on the vehicle speed V (wheel speed Vw) and the steering angle As obtained as traveling information on the vehicle 1. The travel path calculation unit 52 develops the travel path Tvd of the vehicle 1 obtained from the vehicle model on a virtual space 60 formed in a storage area 21a of the door ECU 21 (see FIG. 2). Further, the non-detection field movement path calculation unit 53 associates the calculation result of the non-detection field calculation unit 51, namely, the non-detection field Rnd with the travel path Tvd of the vehicle 1 and continuously develops them on the virtual space 60. As a result, the movement path Trnd of the non-detection field Rnd extending along the travel path Tvd of the vehicle 1 is developed in the virtual space 60.

Further, the door opening operation path calculation unit 54 holds, as opening operation information on each vehicle door 10, the length and the full open angle θ0 of the vehicle door 10 in the longitudinal direction of the vehicle and the first and second restricted angles θ1 and θ2 for the door check device 20. Further, the door opening operation path calculation unit 54 associates the opening operation path Tdr (see FIG. 3, Tdr0 to Tdr2) having three stages calculated based on the opening operation information on each vehicle door 10 with the travel path Tvd of the vehicle 1 and develops them in the virtual space 60. The door opening restriction calculation unit 55 determines whether the vehicle door 10 may operate to open beyond the movement path Trnd of the non-detection field Rnd by monitoring the overlapping between the movement path Trnd of the non-detection field Rnd and the opening operation path Tdr of the vehicle door 10 developed in the virtual space 60.

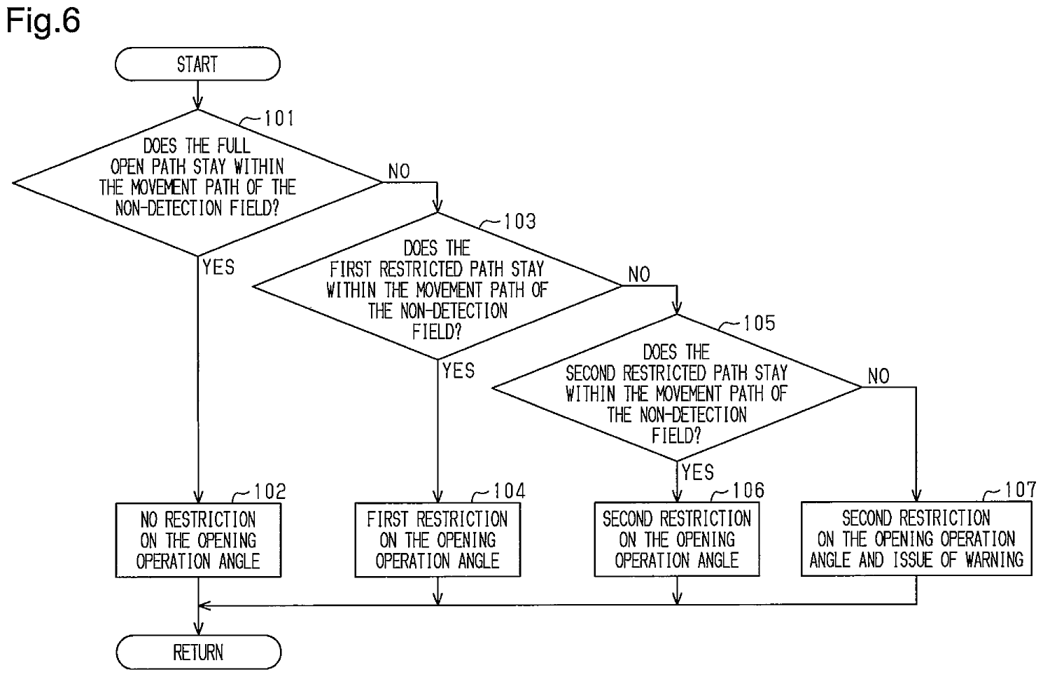

Specifically, as shown in FIG. 3 and the flowchart of FIG. 6, the door opening restriction calculation unit 55 first determines whether the opening operation path Tdr when the vehicle door 10 is operated to open up to the full open angle θ0, namely, the full open path Tdr0 stays within the movement path Trnd of the non-detection field Rnd (Step 101). If the full open path Tdr0 stays within the movement path Trnd of the non-detection field Rnd (YES in Step 101), the door opening restriction calculation unit 55 generates a control signal Sc indicative that the door check device 20 will not restrict the opening operation angle θ (Step 102).

If the full open path Tdr0 of the vehicle door 10 exceeds the movement path Trnd of the non-detection field Rnd (NO in Step 101), the door ECU 21 determines whether a first restricted path Tdr1 when the opening operation angle θ is restricted to the first restricted angle θ1 stays within the movement path Trnd of the non-detection field Rnd (Step 103). If the first restricted path Tdr1 stays within the movement path Trnd of the non-detection field Rnd (YES in Step 103), the door ECU 21 generates a control signal Sc to control the actuation of the door check device 20 such that the opening operation angle θ of the vehicle door 10 is restricted to the first restricted angle θ1 (first restriction on the opening operation angle, Step 104).

If the first restricted path Tdr1 of the vehicle door 10 exceeds the movement path Trnd of the non-detection field Rnd (NO in Step 103), the door ECU 21 determines whether a second restricted path Tdr2 when the opening operation angle θ is restricted to the second restricted angle θ2 stays within the movement path Trnd of the non-detection field Rnd (Step 105). If the second restricted path Tdr2 stays within the movement path Trnd of the non-detection field Rnd (YES in Step 105), the door ECU 21 generates a control signal Sc to control the actuation of the door check device 20 such that the opening operation angle θ of the vehicle door 10 is restricted to the second restricted angle 82 (second restriction on the opening operation angle, Step 106).

Even if the second restricted path Tdr2 of the vehicle door 10 exceeds the movement path Trnd of the non-detection field Rnd (NO in Step 105), the door ECU 21 generates the control signal Sc to control the actuation of the door check device 20 such that the opening operation angle θ of the vehicle door 10 is restricted to the second restricted angle θ2. In addition to the restriction control of door opening, the door ECU 21 issues a warning indicative that the vehicle door 10 may contact the obstacle X in proximity to the vehicle 1 upon opening operation of the vehicle door 10 (second restriction on the opening operation angle and issue of warning, Step 107).

The door ECU 21 activates a loudspeaker 65 (see FIG. 2) arranged in the passenger compartment, for example, inside the vehicle door 10 to issue a warning such as an alarm sound or a voice. In this manner, the door opening restriction device 50 calls attention of the occupant who opens the vehicle door 10.

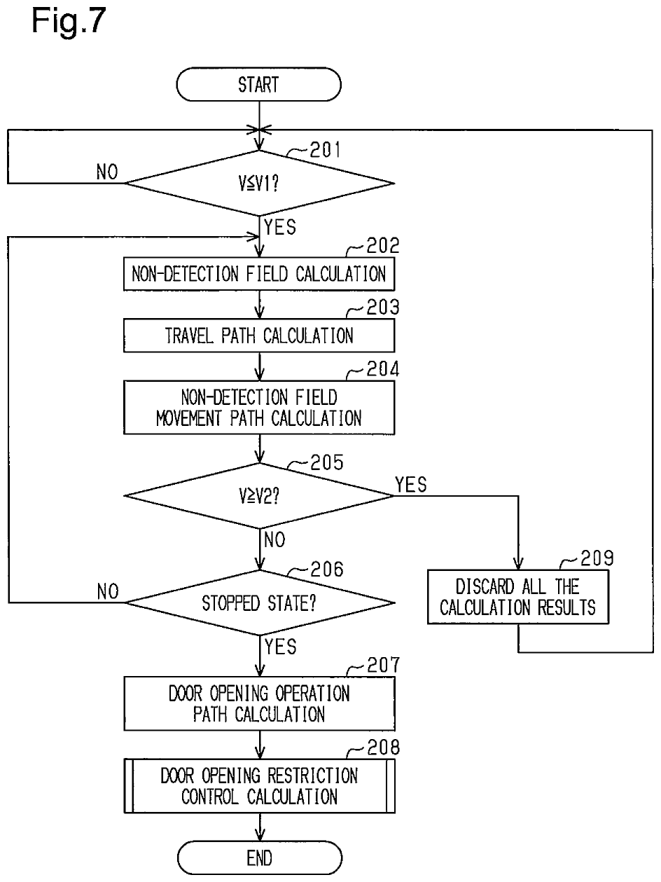

More specifically, as shown in the flowchart of FIG. 7, the door ECU 21 in door opening restriction control first determines whether the vehicle speed V is equal to or less than a predetermined speed V1 (Step 201). The predetermined speed V1 is set to about 10 km/h, for example. If the vehicle speed V is equal to or less than the predetermined speed V1 (V≤V1, YES in Step 201), the door ECU 21 performs non-detection field calculation, travel path calculation, and non-detection field movement path calculation based on a determination that the vehicle 1 is in a traveling state immediately before a stop (Steps 202 to 204).

Next, the door ECU 21 determines whether the vehicle speed V is equal to or more than a predetermined speed V2, which is faster than the predetermined speed V1 (Step 205). If the vehicle speed V is less than the predetermined speed V2 (steV<V2, NO in Step 205), the door ECU 21 determines whether the vehicle 1 is in a stopped state (Step 206). Specifically, of those signals obtained via the in-vehicle network 22 as described above, if the ignition signal Sig of the vehicle 1 indicates OFF and the shift position signal Ssp indicates the parking position, the door ECU 21 determines that the vehicle 1 is in the stopped state. In Step 206, if the vehicle 1 is not determined to be in the stopped state (NO in Step 206), the door ECU 21 repeats processing in Steps 202 to 205 and 206. If the door ECU 21 determines that the vehicle 1 is in the stopped state (YES in Step 206), the door ECU 21 performs the door opening operation path calculation (Step 207) and door opening restriction control calculation (Step 208).

In Step 205, if the vehicle speed V is determined to be equal to or more than a predetermined speed V2 (V V2, YES in Step 205), the door ECU 21 discards all the calculation results in Steps 202 to 204 that have been performed (Step 209). Then the door ECU 21 performs each process from Step 201 again.

In the following, the operation of the door opening restriction device 50 will be described.

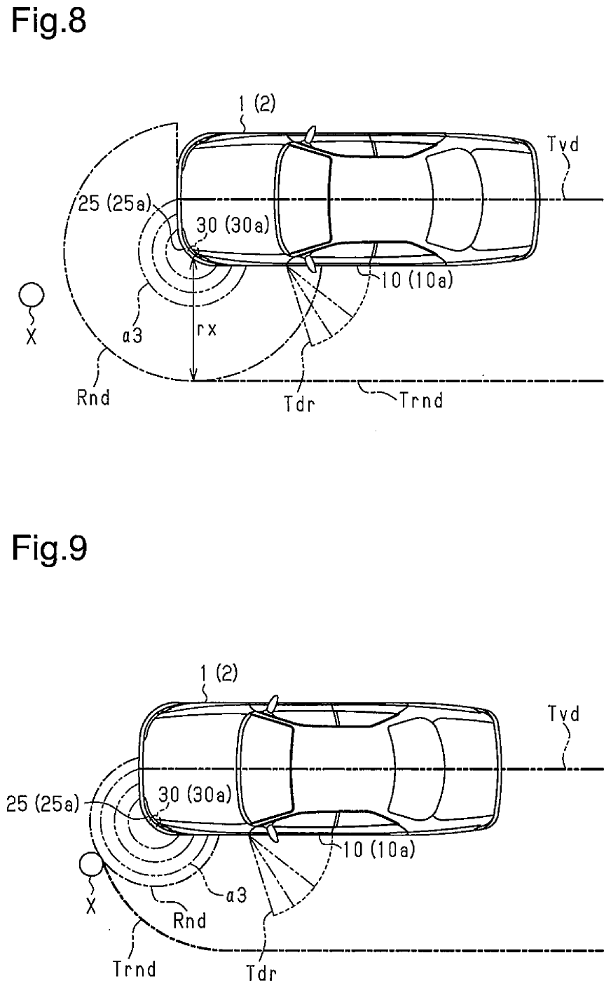

As shown in FIG. 8, if there is no detectable obstacle X in the vicinity of the vehicle 1, the non-detection field Rnd of the obstacle X is equal to an area within a predetermined distance rx with reference to the corner 25 (25a) of the vehicle body 2 where the corner sensor 30 (30a) is arranged. The movement path Trnd of the non-detection field Rnd extends along the travel path Tvd of the vehicle 1 in the travel direction of the vehicle 1.

In the example shown in FIG. 8 and the examples in FIGS. 9 to 17 to be referenced below, the vehicle 1 is in a forward movement state immediately before a stop. In each of the drawings, the travel path Tvd of the vehicle 1 shown by a thick long dashed double-short dashed line corresponds to passing points of the center of the front end of the vehicle 1. In each of the drawings, a thick long dashed short dashed line represents the outer edge of the movement path Trnd of the non-detection field Rnd.

For illustrative purposes, each of the drawings has the opening operation path Tdr of the vehicle door 10 (10a) when the vehicle 1 stops at a location shown in each drawing. As shown in FIG. 8, the door opening restriction device 50 is configured such that the opening operation path Tdr of the vehicle door 10 stays within the movement path Trnd of the non-detection field Rnd if the non-detection field Rnd defined by the predetermined distance rx is maintained, namely, if there is no detectable obstacle X in the vicinity of the vehicle 1.

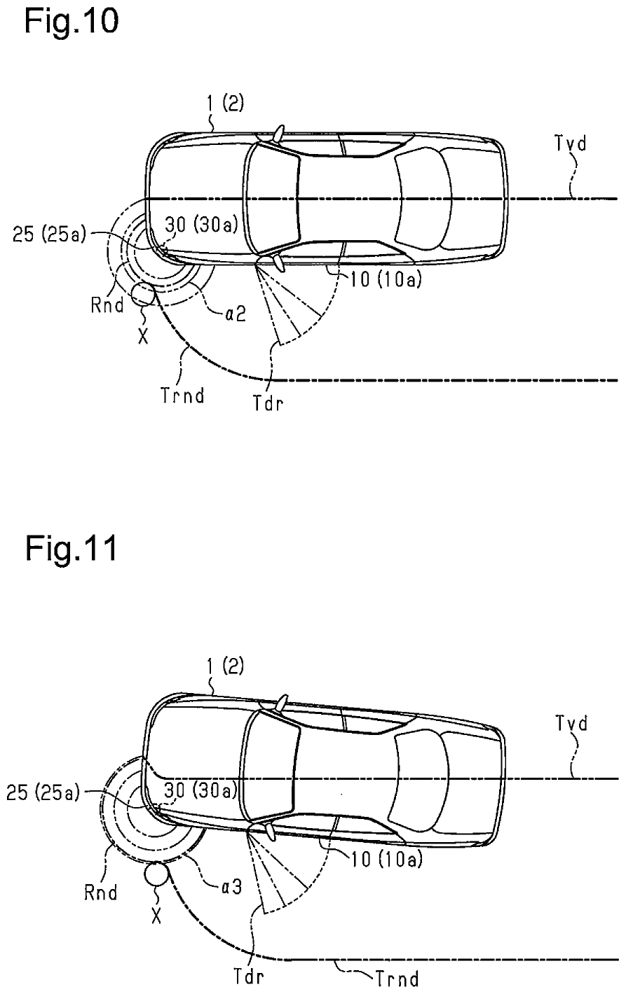

In the examples shown in FIGS. 9 and 10, with the forward movement of the vehicle 1, the obstacle X approaches the corner 25 (25a) at the left end in the front of the vehicle where the corner sensor 30 (30a) is arranged. In this case, as the proximity distance r of the obstacle X detected based on a sensor output Sx of the corner sensor 30 becomes smaller, the non-detection field Rnd of the obstacle X is gradually reduced. Accordingly, the movement path Trnd of the non-detection field Rnd extends in the travel direction of the vehicle 1 to trace the contour of the obstacle X facing the vehicle 1.

In the example shown in FIG. 10, the obstacle X is in proximity, up to the second obstacle detection field α2, to the corner 25 (25a) where the corner sensor 30 (30a) is arranged. In response to a warning using an alarm sound issued in this case, the driver changes the travel course of the vehicle 1 in an attempt to avoid the obstacle X as shown in FIGS. 11 to 17.

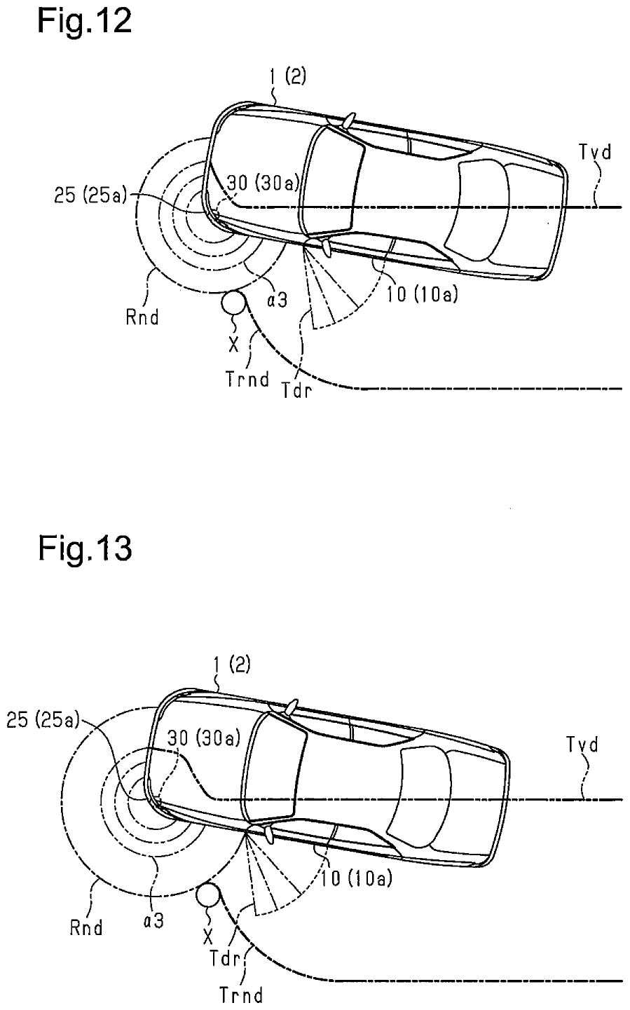

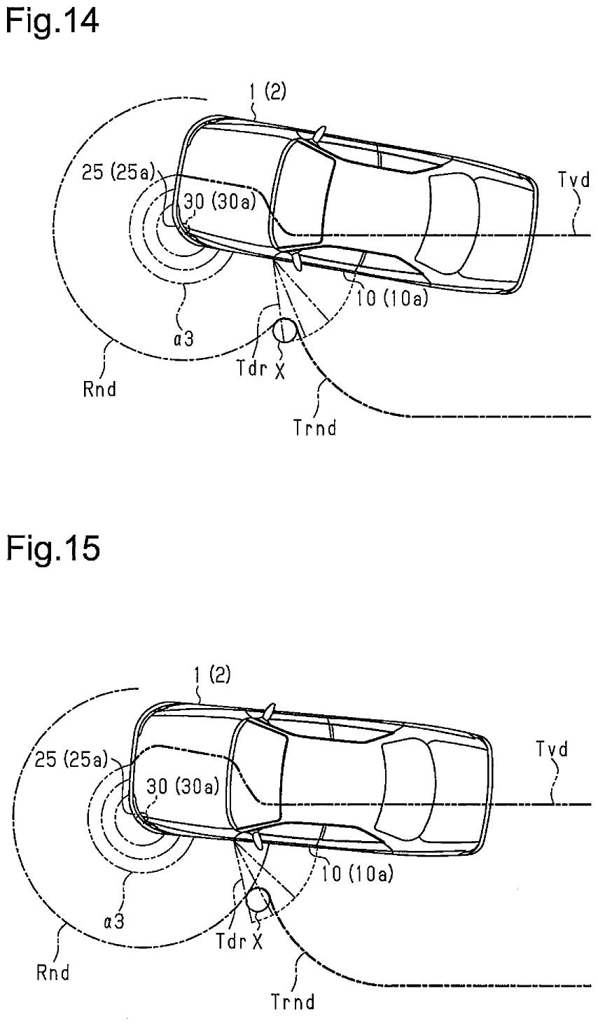

Specifically, as shown in FIGS. 11 and 12, the driver turns the vehicle 1 to the right (clockwise in each drawing) in the travel direction until the alarm sound ends, namely, until the obstacle X goes out of the third obstacle detection field α3. Further, as shown in FIGS. 12 to 14, the driver maintains the travel direction of the vehicle 1 for a while after the obstacle X goes out of the third obstacle detection field α3 and the alarm sound ends. Then, as shown in FIGS. 14 to 17, the driver turns the vehicle 1 to the left in the travel direction (counterclockwise in each drawing). In this manner, the driver returns the travel course of the vehicle 1 to the travel direction (left in each drawing) maintained before the series of the above operations to avoid the obstacle.

In other words, as shown in FIG. 17, in this example, the travel path Tvd of the vehicle 1 meanders to the right in the travel direction of the vehicle 1 (right in FIG. 17) in a section in which the corner 25 (25a), where the corner sensor (30a) is arranged, goes through the vicinity of the obstacle X. However, in this case, as shown in FIGS. 12 to 17, as the proximity distance r of the obstacle X detected based on the sensor output Sx of the corner sensor 30 is changed, the non-detection field Rnd is gradually increased or reduced. The door opening restriction device 50 restricts the opening operation angle θ of the vehicle door 10 such that the vehicle door 10 (10a) upon opening operation does not touch the obstacle X by extending the movement path Trnd of the non-detection field Rnd in the travel direction of the vehicle 1 to trace the contour of the obstacle X even if the travel course of the vehicle 1 is changed as mentioned above.

Specifically, if the vehicle 1 stops at the location shown in FIG. 14, the opening operation angle θ of the vehicle door 10 (10a) located in the vicinity of the obstacle X is restricted to the first restricted angle 81 (see FIG. 3). If the vehicle 1 stops at the location shown in FIG. 15, the opening operation angle θ of the vehicle door 10 (10a) is restricted to the second restricted angle θ2 (see FIG. 3).

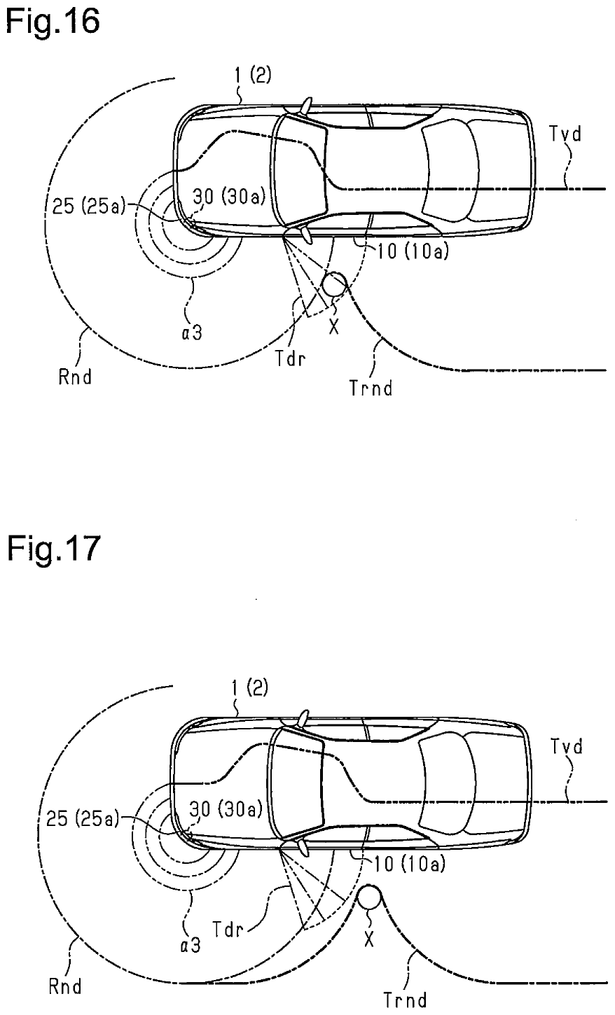

If the vehicle 1 stops at the location shown in FIG. 16, the opening operation angle θ of the vehicle door 10 (10a) is restricted to the second restricted angle θ2 and a warning indicative that the vehicle door 10 (10a) upon opening operation may contact the obstacle X is issued. As shown in FIG. 17, if the vehicle 1 stops at the location where the vehicle door 10 (10a) has run past the vicinity of the obstacle X, the restriction on the opening operation angle of the vehicle door 10 is cancelled.

As described above, the present embodiment provides the following advantages.

(1) The door ECU 21 includes the non-detection field calculation unit 51 that calculates the non-detection field Rnd of the obstacle X with reference to the location of the proximity sensor 40 (corner sensor 30) arranged in the vehicle 1, and the travel path calculation unit 52 that calculates the travel path Tvd until the vehicle 1 comes to the stopped state. Further, the door ECU 21 includes the non-detection field movement path calculation unit 53 that calculates the movement path Trnd of the non-detection field Rnd associated with the travel path Tvd of the vehicle 1, and the door opening operation path calculation unit 54 that calculates the opening operation path Tdr of the vehicle door 10 when the vehicle 1 is in the stopped state. Further, the door ECU 21 includes the door opening restriction calculation unit 55 that generates the control signal Sc of the door check device 20 in order to restrict the opening operation angle θ of the vehicle door 10 if the vehicle door 10 may operate to open beyond the movement path Trnd of the non-detection field Rnd.

With the above-mentioned structure, even if the travel course of the vehicle 1 is changed immediately before the vehicle 1 stops, whether the vehicle door 10 upon opening operation may contact the obstacle X in proximity to the vehicle 1 is determined with improved accuracy. Further, the contact between the vehicle door 10 and the obstacle X is prevented more effectively based on this determination result by restricting the opening operation angle θ of the vehicle door 10.

(2) The door opening restriction calculation unit 55 generates the control signal Sc, which indicates that the opening operation angle θ of the vehicle door 10 should be restricted such that the opening operation path Tdr of the vehicle door 10 stays within the movement path Trnd of the non-detection field Rnd. This effectively prevents the contact between the vehicle door 10 and the obstacle X.

(3) If the opening operation path Tdr of the vehicle door 10 cannot stay within the movement path Trnd of the non-detection field Rnd by the restriction on the opening operation angle θ, the door opening restriction calculation unit 55 issues a warning indicative that the vehicle door 10 upon opening operation may contact the obstacle X. In this manner, the door opening restriction calculation unit 55 calls attention of the occupant who opens the vehicle door 10 and more effectively prevents the contact between the vehicle door 10 and the obstacle X.

The above embodiment may be modified as follows.

In the above embodiment, the door opening restriction device is embodied by the door opening restriction device 50, which restricts the opening operation angle θ of the swing vehicle door 10, which opens and closes the door opening 3 formed on a side of the vehicle body 2. However, the embodiment is not limited to this. The type and arrangement of the vehicle door 10 may be changed arbitrarily. For example, the door opening restriction device may be applied to a hatchback rear door arranged in a rear opening of the vehicle. In other words, the non-detection field Rnd of the obstacle X and its movement path Trnd, and the opening operation path Tdr of the vehicle door 10 may be calculated in a three-dimensional space. Further, the door opening restriction device may be applied to a rear-hinged door, a slide door, or a gull-wing door as a vehicle door.

In the above embodiment, the corner sensor 30 (30a to 30d) arranged at each corner 25 (25a to 25d) of the vehicle body 2 is used as the proximity sensor 40 for detecting the obstacle X. However, the embodiment is not limited to this. The arrangement of the proximity sensor 40 in the vehicle 1 may be changed arbitrarily.

In the above embodiment, if the vehicle 1 is in a traveling state immediately before a stop, the door ECU 21 performs non-detection field calculation, travel path calculation, and non-detection field movement path calculation while the vehicle 1 is traveling (see FIG. 7). However the embodiment is not limited to this. The CU 21 may continuously store the sensor output Sx to be used for the non-detection field calculation and the traveling information (As, Vm) on the vehicle 1 to be used for the travel path calculation. After the vehicle 1 is stopped, the door ECU 21 may perform the non-detection field calculation, the travel path calculation, and the non-detection field movement path calculation based on the stored sensor output Sx and traveling information.

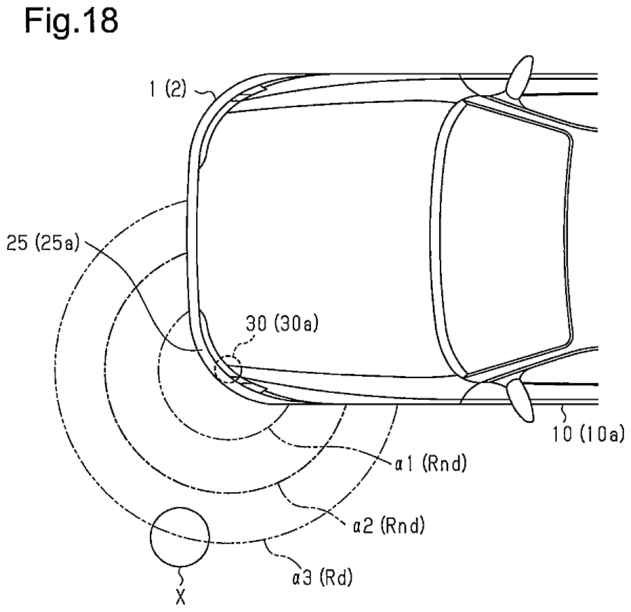

In the above embodiment, if the obstacle X is detected based on the sensor output Sx of the corner sensor (proximity sensor 40), the non-detection field calculation unit 51 sets the inside of the detected proximity distance r as the non-detection field Rnd of the obstacle X. However, the embodiment is not limited to this. As shown in FIG. 18, the non-detection field calculation unit 51 may set the non-detection field Rnd of the obstacle X on the basis of in which of the obstacle detection fields (α1 to α3) formed by partitioning a detectable area Rd of the obstacle X formed by the proximity sensor 40, the obstacle X is detected.

FIG. 18 shows an example in which the obstacle X is detected in the third obstacle detection field α3. In this case, the second obstacle detection field α2, which is the outermost obstacle detection field where the obstacle X is not detected, and the inside thereof, namely, the first and second obstacle detection fields α1 and α2 are set as the non-detection field Rnd. If the obstacle X is detected in the second obstacle detection field α2, the first obstacle detection field α1 may be set as the non-detection field Rnd. In this case, the body ECU 41 outputting the sensor output Sx to the door ECU 21 constitutes a field partitioning unit, which partitions the detectable area Rd of the obstacle X in accordance with the proximity distance r.

With this configuration, even if detection accuracy of the proximity distance r by the proximity sensor is low, the non-detection field Rnd is appropriately set. Even in a case where only limited detection information on the sensor output Sx of the proximity sensor 40, for example, “in which of the obstacle detection fields (α1 to α3) the obstacle X is detected” may be obtained, the non-detection field Rnd is appropriately set.

Further, in the above-mentioned embodiment, the door ECU 21 obtains the sensor output Sx of each corner sensor 30, specifically, the proximity distance r of the obstacle X indicated in the sensor output Sx, from the body ECU 41 via the in-vehicle network 22. However, the embodiment is not limited to this. The door ECU 21 may directly obtain the sensor output Sx of the proximity sensor 40.

In the above-mentioned embodiment, if the ignition signal Sig indicates OFF and the shift position signal Ssp indicates the parking position, the vehicle 1 is determined to be in the stopped state. However, the embodiment is not limited to this. The manner in which the vehicle 1 is determined to be in a stopped state may be changed arbitrarily, for example, by determining based on the vehicle speed V.

In the above-mentioned embodiment, the opening operation angle θ of the vehicle door 10 is restricted in three stages (80, 81, and 82) by the actuation of the door check device 20 controlled by the door ECU 21. However, the embodiment is not limited to this. The mechanical structure for restricting the opening operation angle θ of the vehicle door 10 may be changed arbitrarily. For example, the opening operation angle θ may be restricted in two stages or multiple stages equal to or more than four. The opening operation angle θ may be restricted without stages to have an arbitrary opening operation angle θ.

The door opening restriction device may be embodied by the door opening restriction device 50 that restricts the opening operation angle θ, which may be applied not only to a vehicle door being opened manually but also to a vehicle door operating to open automatically with a driving source. In this case, the opening operation angle θ of the vehicle door may be restricted through control of an actuator that opens and closes the vehicle door, for example.

1. A door opening restriction device comprising:
a non-detection field calculation unit that calculates, based on a sensor output of a proximity sensor arranged in a vehicle, a non-detection field of an obstacle with reference to a location of the proximity sensor;
a travel path calculation unit that calculates, based on traveling information on the vehicle, a travel path until the vehicle comes to a stopped state;
a non-detection field movement path calculation unit that calculates a movement path of the non-detection field associated with the travel path of the vehicle;
a door opening operation path calculation unit that calculates an opening operation path of a vehicle door when the vehicle is in the stopped state; and
a door opening restriction unit that restricts an opening operation angle of the vehicle door in a case where the vehicle door may operate to open beyond the movement path of the non-detection field.

2. The door opening restriction device according to claim 1, wherein the door opening restriction unit restricts the opening operation angle of the vehicle door such that the opening operation path of the vehicle door stays within the movement path of the non-detection field.

3. The door opening restriction device according to claim 1, comprising a field partitioning unit partitioning a detectable area of the obstacle formed by the proximity sensor into a plurality of obstacle detection fields in accordance with a proximity distance to the proximity sensor,
wherein the non-detection field calculation unit sets, as the non-detection field, an inside of an outermost one of the obstacle detection fields where the obstacle is not detected.

4. An opening operation control method for a vehicle door comprising:
calculating, based on a sensor output of a proximity sensor arranged in a vehicle, a non-detection field of an obstacle with reference to a location of the proximity sensor;
calculating, based on traveling information on the vehicle, a travel path until the vehicle comes to a stopped state;
calculating a movement path of the non-detection field associated with the travel path of the vehicle;
calculating an opening operation path of a vehicle door when the vehicle is in the stopped state; and
restricting an opening operation angle of the vehicle door in a case where the vehicle door may operate to open beyond the movement path of the non-detection field.

5. The opening operation control method for a vehicle door according to claim 4, wherein the restricting the opening operation angle of the vehicle door is performed such that the opening operation path of the vehicle door stays within the movement path of the non-detection field.

6. The opening operation control method for a vehicle door according to claim 4, comprising partitioning a detectable area of the obstacle formed by the proximity sensor into a plurality of obstacle detection fields in accordance with a proximity distance to the proximity sensor,
wherein the calculating the non-detection field sets, as the non-detection field, an inside of an outermost one of the obstacle detection fields where the obstacle is not detected.

7. The opening operation control method for a vehicle door according to claim 4, further comprising issuing a warning indicative that the vehicle door upon opening operation may contact the obstacle in a case where the opening operation path of the vehicle door cannot stay within the movement path of the non-detection field by the restriction on the opening operation angle.
